(19) United States
(12) Patent Application Publication
(10) Pub. No.: US 2014/0255895 A1
(43) Pub. Date: Sep. 11, 2014

(54) SYSTEM AND METHOD FOR TRAINING AGENTS OF A CONTACT CENTER

(71) Applicant: AVAYA INC., Basking Ridge, NJ (US)

(72) Inventors: Shmuel Shaffer, Palo Alto, CA (US); Reinhard P. Klemm, Basking Ridge, NJ (US)

(73) Assignee: AVAYA INC., Basking Ridge, NJ (US)

(21) Appl. No.: 13/787,627

(22) Filed: Mar. 6, 2013

(51) Int. Cl. G09B 7/02

(52) U.S. Cl. CPC G09B 7/02
USPC 434/350

(57) ABSTRACT

A training system for providing training to agents of an enterprise is provided. The training system may include a retrieval module for retrieving content from at least one predetermined resource. The training system further may include a topic determining module for determining at least one topic based on the retrieved content. The training system further may include an answer selecting module for selecting an answer for the at least one topic from the retrieved content based upon predefined rules. The training system further may include a reporting module for reporting the at least one topic and answer to one or more agents of the enterprise.

### BACKGROUND

1. Field of the Invention

Embodiments of the present invention generally relate to a system and method for training agents of an enterprise and particularly to a system and method for providing supplemental training to the agents utilizing online available information.

2. Description of Related Art

The quality of remote customer service, provided by a contact center, can be a valuable differentiator for a competitive business. Contact centers are typically prepared for responding to predictable questions and requests from customers. However, businesses that provide complex services, sell complex products, change their products and services frequently, sell products and services that are often used in conjunction with other business' products, or change customer-facing business processes often, may experience a high number of unexpected customer questions or requests. For example, a customer buys a new computer model from its manufacturer ‘A’, a wireless router from manufacturer ‘B’, and a wireless printer from company ‘C’. The customer connects the three devices, but is unable to print documents from his computer to the printer and calls A's customer support. Because the computer is a new model, A's customer support may not be experienced with this customer's problem and perhaps its diagnostics tools are unable to pinpoint the problem. It is also possible that the problem does not lie with the computer but rather with the interplay between the three devices, but A's customer support is not familiar with this configuration and since ‘A’ does not manufacture the wireless router or the printer, it may be unable to advise the customer. It is possible that the configuration of the three devices is exposing a bug in the wireless router or the printer. Whether the problem lies with the computer or not, and wherever the problem lies, it would be advantageous for ‘A’ to solve the customer's problem and solve it quickly, to increase customer satisfaction and reduce its customer service cost.

However, ‘A’ may not be prepared to do it because it did not foresee this problem and is unfamiliar with products that it does not manufacture. In addition to being unprepared for the topic that the customer raises, A's customer service may also be unprepared for the twists and turns of the conversation between the customer and the customer service. Contact center agents receive training in the topics that they will need to talk to customers about and they are being coached to carry on conversations about these topics. The selection of topics and the conversation coaching are manual tasks carried out by the contact center management. Agent scripting software supports agents in conversing with customers. Some communication modalities between customers and agents, e.g., text chat, are often integrated with scripting engines to automatically execute routine parts of conversations (“automated agents”). For example, obtaining the customer's name and inquiring about the customer's concern are often automated in text chat.

Training agents, customizing agent scripting software, and coaching agents relies on a manual selection of topics, problem solutions, and conversation patterns. As such, the selection, breadth, and depth are limited, and can lag significantly behind relevant developments (new topics, changed or new problem solutions, gradual changes in conversation patterns, etc.). These limitations affect both human agents as well as automated interactions with customers.

Ultimately, the customer in the above scenario may be disappointed by the lack or slow speed of help from the customer service. The customer may turn to online resources including social network sites, micro blogs, and online help forums for help. Online resources, where users help each other, without being constrained by the corporate provenance of products and services, legal restrictions, liability concerns, and with a vast experience with actual customer concerns, problems, and solutions, can be of much more help than A's customer service. However, online resources are typically uncurated, posts may provide incorrect, misleading, or suboptimal advice, and the sheer volume of user posts to review may be daunting task for the customer. Sometimes, if the customer cannot find an answer to his or her questions on social network sites, micro blogs, or online forums, the customer can post a question online to seek advice from other users. However, there is no guarantee that anybody will answer or answer within an acceptable time window.

There is thus a need for an improved customer support service system and method to provide additional training to customer service agents and solve any type of customer query in real-time.

### SUMMARY

Embodiments in accordance with the present invention provide a training system for providing training to agents of an enterprise. The training system may include a retrieval module for retrieving content from at least one predetermined resource. The training system further may include a topic determining module for determining at least one topic based on the retrieved content. The training system further may include an answer selecting module for selecting an answer for the at least one topic from the retrieved content based upon predefined rules. The training system further may include a reporting module for reporting the at least one topic and answer to one or more agents of the enterprise.

Embodiments in accordance with the present invention further provide a computer-implemented method for training agents of an enterprise. The computer-implemented method may include retrieving content from at least one predetermined resource, determining at least one topic based on the retrieved content, selecting an answer for the at least one topic from on the retrieved content based on predefined rules, and reporting the at least one topic and answer to one or more agents of the enterprise and/or to an automated agent system if one is included in the enterprise.

Embodiments in accordance with the present invention further provide a computer readable medium storing computer readable instructions when executed by a processor perform a method. The method may include retrieving content from at least one predetermined resource, determining at least one topic based on the retrieved content, selecting an answer for the at least one topic from on the retrieved content based on predefined rules, and reporting the at least one topic and answer to one or more agents of the enterprise.

Embodiments of the present invention may provide a number of advantages depending on the particular configuration. First, embodiments of the present invention provide a training system that supplements existing training and knowledge base that human and automated agents can use during customer interactions. The supplemental knowledge base thus expands and transcends internal knowledge in a given business. The supplemental knowledge base may include topics and conversational patterns that include user questions and answers, and is drawn from actual online conversations that users have about the business' products and services. The supplemental knowledge having actual concerns, problems, questions, and issues that users experience, together with potential answers and solutions, can be absorbed by the agent scripting software, screen pop software, and automated text chat conversational software (i.e., a “chat robot” or “chat bot”). The knowledge can be used in training of human agents in the business' contact center to better handle customer calls. The customer call may have increased first contact resolution, higher customer satisfaction, and fewer unresolved customer issues.

Further, embodiments of the present invention provide unorthodox sources of knowledge for the agents training, for example, social network sites of competitors and businesses, whose services and products can be or are often used in conjunction with this business' products and services. Embodiments may utilize conversations on social network sites and in online forums between other business' contact centers and their customers to build expanded knowledge, thus improving human and automated agent training.

These and other advantages will be apparent from the disclosure of embodiments of the invention(s) contained herein.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an example system embodiment of the present invention;

FIG. 2 illustrates an exemplary architecture in which the various embodiments may be implemented;

FIG. 3 illustrates a flowchart depicting an embodiment of the present invention;

FIG. 4 illustrates a flowchart depicting use of expanded knowledge base, in accordance with an embodiment of the present invention; and

FIG. 5 illustrates an exemplary user posts on an online resource.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of the present invention will be illustrated below in conjunction with an exemplary communication system, e.g., the Avaya Aura® system. Although well suited for use with, e.g., a system having an ACD or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media may include, for example, NVRAM, or magnetic or optical disks. Volatile media may include dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments of the present invention are considered to include a tangible storage medium or distribution medium and prior art-recognized equivalents and successor media, in which the software implementations of the present invention are stored.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments of the present invention may include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

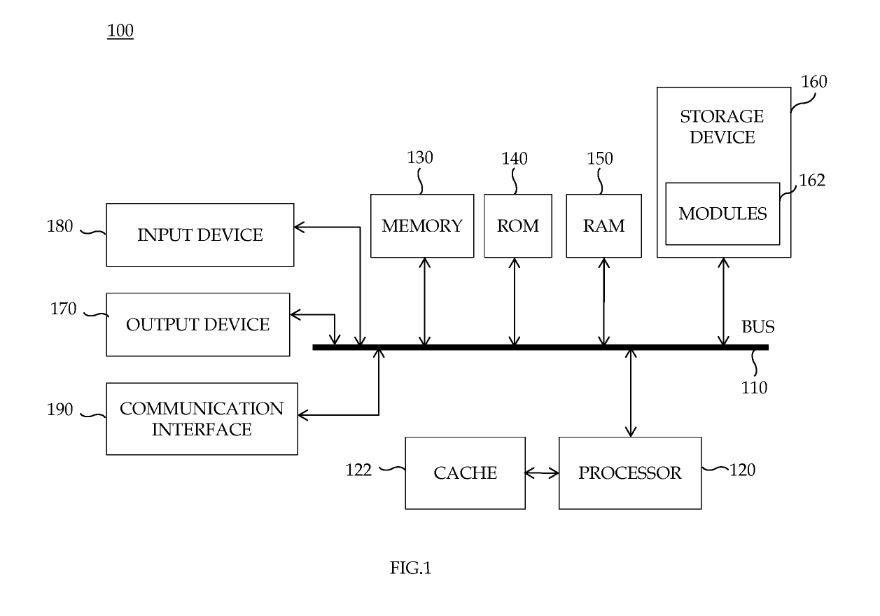

With reference to FIG. 1, an exemplary system 100 may include a general-purpose computing device 100, including a system bus 110 and a processing unit (CPU or processor) 120 that couples various system components including the system memory 130 such as read only memory (ROM) 140 and random access memory (RAM) 150 to the processor 120. The system 100 may include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules may control or be configured to control the processor 120 to perform various actions. Other system memory 130 may be available for use as well. The memory 130 may include multiple different types of memory with different performance characteristics. It may be appreciated that the disclosure may operate on a computing device 100 with more than one processor 120 or on a group or cluster of computing devices networked together to provide greater processing capability. The processor 120 may include any general purpose processor and a hardware module or software module 162 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further may include storage devices 160 such as a hard disk drive, a magnetic disk drive, an optical disk drive, tape drive or the like. The storage device 160 may include software modules 162 for controlling the processor 120. Other hardware or software modules are contemplated. The storage device 160 is connected to the system bus 110 by a drive interface. The drives and the associated computer readable storage media provide non-volatile storage of computer readable instructions, data structures, program modules and other data for the computing device 100. In one embodiment of the present invention, a hardware module that performs a particular function may include the software component stored in a computer-readable medium in connection with the necessary hardware components, such as the processor 120, bus 110, output device 170, and so forth, to carry out the function. The basic components are known to those of skill in the art and appropriate variations are contemplated depending on the type of device, such as whether the system 100 is a small, handheld computing device, i.e., a smartphone, a desktop computer, or a computer server.

Although the exemplary embodiment described herein employs the storage device 160, it should be appreciated by those skilled in the art that other types of computer readable media which may store data that are accessible by a computer, such as magnetic cassettes, flash memory cards, digital versatile disks, cartridges, read only memory (ROM) 140, random access memories (RAMs) 150, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 180 represents any number of input mechanisms, such as a microphone for speech, a touch-sensitive screen for gesture or graphical input, keyboard, mouse, motion input, speech and so forth. An output device 170 may also be one or more of a number of output mechanisms known to those of skill in the art. In some instances, multimodal systems enable a user to provide multiple types of input to communicate with the computing device 100. Communication interface 190 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labelled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. Further, use of the term “processor” should not be construed to refer exclusively to hardware capable of executing software. Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 may practice all or part of the recited methods, may be a part of the recited systems, and/or may operate according to instructions in the recited non-transitory computer-readable storage media. Such logical operations may be implemented as modules configured to control the processor 120 to perform particular functions according to the programming of the module. For example, FIG. 1 illustrates the modules 162 in the storage device 160 configured to control the processor 120. These modules may be stored on the storage device 160 and loaded into RAM 150 or memory 130 at runtime or may be stored as would be known in the art in other computer-readable memory locations.

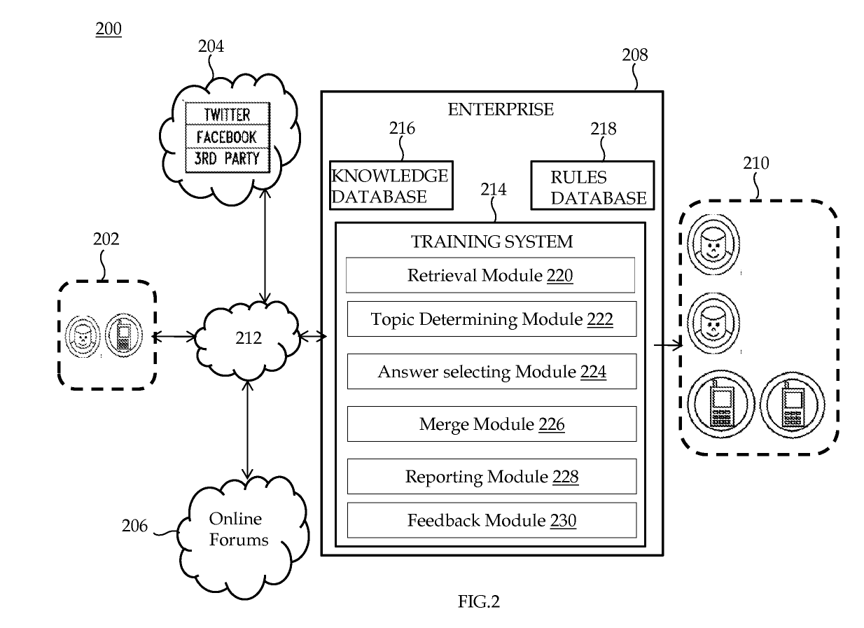

Having disclosed some components of a computing system, the disclosure now turns to FIG. 2, which illustrates an exemplary architecture 200 in which the various embodiments of the present invention may be implemented. As shown in FIG. 2, the exemplary architecture 200 may include user terminals 202 associated with customers, social media channels 204, online forums 206, an enterprise 208, and an agent terminal 210. The elements 202-208 may be connected via at least one network 212.

The network environment 200 may include a user terminal 202 connected to an enterprise 208 via network 212. The user terminal 202 may include a computing device of the user, for example, a smart phone, a laptop, a desktop, a tablet etc. The network 212 may include, but is not restricted to, a communication network such as the Internet, PSTN, Local Area Network (LAN), Wide Area Network (WAN), Metropolitan Area Network (MAN), and so forth. In an embodiment of the present invention, the network 212 may be a data network such as the Internet.

Further, in another embodiment of the present invention, the user terminal 202 and the enterprise 208 may communicate in various ways. In one embodiment of the present invention, the user makes use of the user terminal 202 to establish a communication session with the enterprise 208. For example, the customer may establish a telephony communication link with the enterprise 208. In another embodiment of the present invention, the customer may establish a communication session with the enterprise over a videophone, instant messaging, or other real-time communications means.

In yet another embodiment of the present invention, one or more time-shifted communications may first occur, followed by a real-time communication session between the customer and the agent of the enterprise 208. For example, a customer may utilize user terminal 202 to indicate their desire to establish a communication session with an agent of the enterprise 208. Such an indication may be by way of providing a message or post on a social media, by sending an email to the enterprise 208, or providing the indication via any other type of time-shifted communication means.

The enterprise 208 may be configured to support the communication modes described above using a wide variety of devices for the user terminals 202, including devices operating over analog or digital communication channels designed for the delivery of information to users in an audio form, a visual form (including static and dynamic visual elements), or any combination thereof. For example, in some embodiments of the present invention, the enterprise 208 may be configured to support the user terminals 202 consisting of a general purpose computer device connected to the data network 212, as described above with respect to FIG. 1. Such devices may include a desktop computer, portable computer, personal digital assistant, smartphone, or any other type of appliance or device having access to one or more data networks supporting real-time and/or time-shifted communication modes over such networks. However, the various embodiments are not limited in this regard. For example the user terminals 202 may be devices supporting real-time and/or time-shifted communications over telephony networks or any other type of communication networks. Such devices may include land-line telephone devices, mobile or cellular telephone devices, videophone devices, and the like.

Additionally, the architecture 200 may include agent terminals 210 associated with agents of the enterprise and configured for providing services to the customers located at the user terminals 202. In particular, the enterprise 208 connects and manages the communication link or session between the user terminals 202 and the agent terminals 210. Although the agent terminals 210 are shown in FIG. 2 as being connected to the network 212 via the enterprise 208, the various embodiments are not limited in this regard. Rather, in some embodiments of the present invention, one or more of the agent terminals 210 may be directly connected to the network 212 and may communicate with the enterprise 208 via network 212. The agent terminals 210, like the user terminals 202 may be configured to support real-time and/or time-shifted communication modes. Accordingly, the description above regarding the communication modes and devices for the user terminals 202 is equally applicable to the agent terminals 210.

Further, the architecture 200 may include a media manager (not shown in figure) that may operate as a gateway to allow the enterprise 208 to communicate with the user terminal 202 in accordance with conventional gateway systems and method. Further, in one embodiment of the present invention, the media manager may map the user's data to actions such as IVR prompt language, music-on-hold choice, agent selection, response time, guiding the agent's interaction with the customer, post-interaction follow-up, virtual background selection for a video-agent, and much more.

Furthermore, the connection between the user terminal 202 and agent terminal 210 is provided via the agent routing module (not shown in figure). In response to a user at the user terminal 202 selecting a particular contact option, the agent router establishes the communication link associated with the selected contact option between the user terminal 202 and the agent terminal 210.

As shown in FIG. 2, social media channels 204 and online forums 206 are accessible through the network 212. The social media channels consist of direct and indirect social media channels, respectively, with respect to the enterprise 208.

As used herein, a “direct” social media channel refers to a social media channel that is directly related or associated with the enterprise 208. For example, the social media channel may be a publically accessible communications channel that is managed and controlled by the customer care center of the enterprise 208, such as a customer support user forum established and managed by the enterprise 208. However, in the various embodiments, such direct social media channels 204 may also include online communications channels which are partially managed or controlled by the enterprise. For example, many product and service offering companies have their pages on social media channels, wherein various users may post their issues/problems related to some products, and the companies or some other users may respond there. For example, a Facebook® or Twitter® site or page established by the enterprise. However, the various embodiments are not limited to the examples above and a direct social media channel 204 may include any other type of communication channel in which the content is at least partially managed or controlled by the enterprise.

In contrast, an “indirect” social media channel refers to a social media channel in which the enterprise 208 is a participant and is not involved in the management, establishment, or control thereof. Such indirect social media channels 204 may include channels that are viewable by the general public, including channels requiring registration or having some type of authentication procedures for accessing the channel. For example, a blog or other online communications channel established by one or more customers of the enterprise. In such a communication channel, the enterprise 208 may monitor and interact with customers, but others may control the content in the communication channel. However, the various embodiments are not limited to the examples above and an indirect social media channel may include any other type of communication channel in which the enterprise does not have control of the content posted thereon.

As shown in FIG. 2, online forums 206 are also accessible through the network 212. The online forums 206 may include online forums (for example, stackoverflow, Yahoo! Answers, T-Mobile Support, tmonews) where users carry on conversations about their business' products and services and products of competitors, business partners, and those of businesses whose products and services may be used in conjunction with their business. Further, the online forums include public discussion groups, wherein users submit their queries (technical as well as non-technical), and other users submits solutions based on their knowledge. The other users may also have faced similar issues in past and hence they share their personal experiences about how they solved this particular issue/problem.

According to an embodiment of the present invention, the enterprise 208 may include a training system 214, a knowledge database 216, and a rules database 218. The training system 214 may include a retrieval module 220, a topic determining module 222, an answer selecting module 224, merge module 226, a reporting module 228, and a feedback module 230.

The retrieval module 220 is configured to retrieve content from preconfigured resources. In an embodiment, the preconfigured resources include public online resources. In another embodiment, the resources may include offline resources. In yet another embodiment, the resources may include online as well as offline resources. The configured set of online resources may include those resources that are owned by a particular business, and further those resources which have some relevance to the business' products and services. The retrieval module 220 may retrieve content from preconfigured resources through their APIs. In an embodiment, the retrieval module 220 periodically retrieves the content on regular intervals set by the user.

Further, the content may include conversation or a series of user posts related to a same topic/issue/problem. The retrieval module 220 retrieves conversations that are new or have changed since the last retrieval cycle. In an embodiment, the retrieval module 220 retrieves content related to preconfigured keywords. The retrieval module 220 may also filter out those conversations that do not contain the desired combination of configured keywords.

The topic determining module 222 is configured to extract discussion topics from the retrieved content or conversations. In an embodiment, the topic determining module 222 automatically extracts discussion topics. For example, many online resources such as ‘Facebook’ or ‘Stackoverflow’ include explicit conversation threads that facilitate the identification of a conversation. Some other online resources such as Twitter do not maintain explicit conversation threads and require an additional analysis to identify what posts belong to the same conversation. The topic determining module 222 utilizes a natural language processing (“NLP”) engine to identify discussion topics from such online resources. The NLP engine extracts those conversations from the retrieved conversations that begin with a question and contain one or more answers. The NLP engine is configured to estimate a likely hood of the conversation beginning with a question and containing answers based upon a configured threshold stored in rules database 218. The topic determining module 222 further stores the discussion topics into the knowledge database 216.

The answer selecting module 224 is configured to select an answer for the discussion topic based upon preconfigured rules stored in the rules database 218. In an embodiment, if a particular discussion topic has many answers, then the answer selecting module 224 selects a best answer from the answers. The answer selecting module 224 may follow whole trail related to a discussion topic on the social media. In an embodiment, the answer selecting module 224 may utilize positive feedback and negative feedback given by users to particular solutions or answers for determining the answer or best answer. For example, if many users have commented like “Well, this worked for me”, or if many users have given thumbs up to a particular solution, the answer selecting module 224 may utilize those feedbacks for judging trustworthiness of the answer/solution.

The merge module 226 is configured to merge identified topic and answer with previously retrieved topics/information. The merge module 226 may classify the discussion topics into classes of similar topics. In an embodiment, the merge module 226 may utilize the NLP engine for classifying the discussion topics. The merge module 226 classifies the retrieved conversations into classes where each conversation begins with a similar question. Further, the merge module 226 merges the newly stored topic and conversation classes with those from previous retrieval cycles, based on similarity. Next, the merge module 226 sorts the topic classes, and the conversation classes according to the class size. Finally, the merge module 226 may store the topic into the knowledge database 216.

The reporting module 228 is configured to report the identified topic and selected answer to agents of the enterprise. The agents may include human agents, agent scripting software, and automated agents who may absorb frequent new topics discussed and conversational patterns. In an embodiment, the agents may learn or absorb ‘n’ new topics, wherein n is a configurable parameter. The reporting module 228 may report the ‘n’ most frequent topics and conversation classes to the agents. In an embodiment, the reporting module 228 may directly report the discussion topics and answer to the agents. In another embodiment, the reporting module 228 may report the discussion topics and answer to a human analyst. The human analyst may index tuples (question, answer) with a question, the corresponding set of answers will be returned. The human analyst may further transfer topics, and user questions paired with answers to agent scripting and automated agent software. During this phase, the human analyst may also curate raw topics and conversations before they are transferred into the agent scripting and automated agent software. The human analyst may also use the information obtained from the retrieval module 220 to continuously and systematically train human agents to improve their performance during customer interactions.

Further, human agents, agent scripting software, and automated agents may use the knowledge database 216 to retrieve an answer for a customer query. The customer query may exactly match with a stored discussion topic or substantially match with a stored discussion topic. The agents may retrieve the answer for the query and provide it to customer. The customer may be satisfied with the answer or may be unsatisfied from the answer. Accordingly, the customers may provide a feedback to the agents.

The feedback module 230 is configured to receive a feedback from a customer/user for the answer. In an embodiment, the feedback module 230 may provide the user an alternative best answer in case of negative feedback. In another embodiment, the feedback module 230 may also ask the retrieval module 220 to go online (e.g. predetermined online resources or general online resources) and search for exact user query for a better answer. The feedback module 230 may further provide to the customer/user new found solution/answer for the user query/problem/issue.

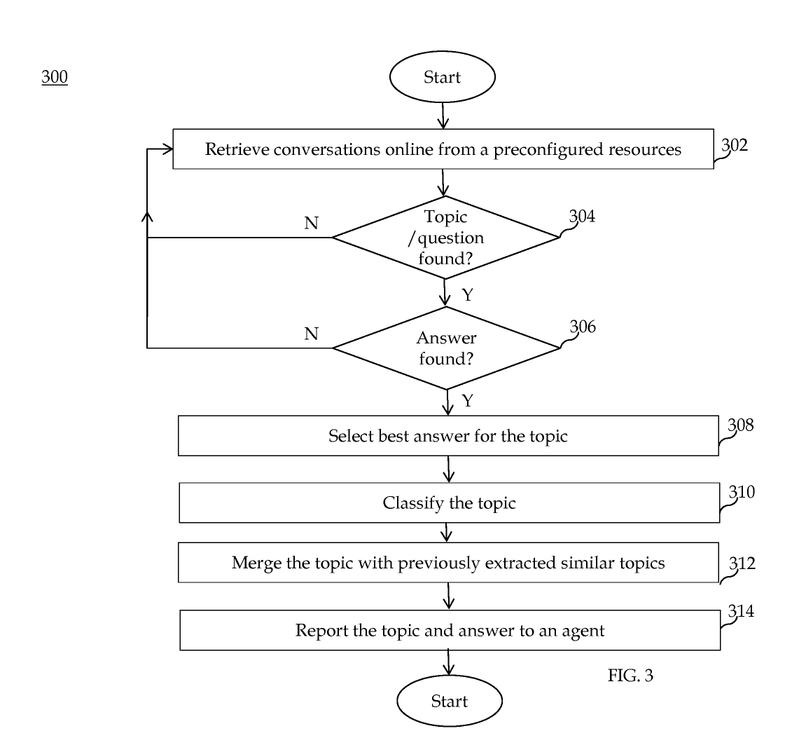

FIG. 3 illustrates a method 300 for building a knowledge database 216 for training of agents. Knowledge may include topics, frequently asked questions, previous answers, identity of information sources for certain subject matter domains, ratings of answers, ratings of answerers, metadata related to the knowledge, and so forth. Embodiments in accordance with the present invention ordinarily will build knowledge base 216 proactively, such that information sources may be monitored for topics, keywords, volume of messaging, and so forth. Volume of messaging involving a topic will change over time (i.e., will trend) as the topic rises or falls in interest. The volume of messaging, its age and/or its trending may be used to determine when to include a topic in the knowledge base 216 or when to exclude or delete it from knowledge base 216. A windowing function may be used to weight at least some categories of the data mining results by age, under the assumption that topic trends may be more relevant when they are more recent.

In other embodiments, knowledge base 216 may be built reactively in response to specific queries from users, or may include both a proactive and reactive mode of adding knowledge to knowledge base 216.

Knowledge database 216 may be used for at least two purposes: First, an “online” mode, such that ongoing conversations between agents and customers may be coached according to the stored conversations. Second, an “offline” mode that may be useful for training of agents (human or automated) in order to improve their future performance in actual conversations. Various filters may be applied to the knowledge retrieved from knowledge base 216. For example, knowledge may be more readily usable or acceptable as its indicia of trustworthiness increases. For example, a filter may be applied such that only knowledge from sources that exceed a predetermined threshold rating level (e.g., stars, “thumbs up”, etc.) will be used.

At step 302, content is retrieved from preconfigured resources. In an embodiment, the resources may include online resources. In another embodiment, the resources may include offline resources. In yet another embodiment, the resources may include online as well as offline resources. Further, the preconfigured set of online resources may include those resources that are owned by a particular business, and further those resources which have some relevance to the business' products and services. The content is retrieved from preconfigured resources for preconfigured keywords through their APIs. In an embodiment, the content may include conversation or a series of user posts related to a same topic/issue/problem. Further, in an embodiment, the content may be periodically retrieved on regular intervals. In an embodiment, the retrieval module 220 may retrieve the content.

At step 304, it is determined whether a topic has been found. In an embodiment, a natural language processing (NLP) engine may be used to identify discussion topics from online resources. If the topic has been found, the method 300 proceeds to step 306. Otherwise, the method 300 returns to step 302. In an embodiment, the topic determining module 222 may determine a topic from the retrieved content.

At step 306, it is determined whether an answer for the topic has been found. If the answer has been found, the method proceeds towards step 308. Otherwise, the method 300 returns at step 302.

At step 308, an answer is selected for the identified discussion topic. In an embodiment, if a particular discussion topic has many answers, then a best answer is determined from the answers, and a whole trail related to a discussion topic on the social media may be followed to determine the best answer. In an embodiment, positive feedback and negative feedback given by users to particular solutions or answers may be utilized for determining the answer or best answer. In an embodiment, the answer selecting module 224 may select the answer from the retrieved content.

At step 310, the discussion topic is classified. The discussion topic may be classified into classes of similar topics stored in the knowledge database 216. In an embodiment, an NLP engine may be utilized for classifying the discussion topics. In an embodiment, the merge module 226 may classify the discussion topics.

At step 312, the discussion topic and answer is merged with existing topic and conversations stored in the knowledge database 216. In an embodiment, the merge module 226 may determine a topic from the retrieved content.

At step 314, the answer and the topic is reported to the agents. The agents may include human agents, agent scripting software, and automated agents. In an embodiment, the discussion topics and answer may be directly reported to the agents. In another embodiment, the discussion topics and answer may be first reported to a human analyst. The human analyst may index tuples (question, answer) with a question, the corresponding set of answers will be returned. The human analyst may further transfer topics, and user questions paired with answers to agent scripting and automated agent software. During this phase, the human analyst may also curate raw topics and conversations before they are transferred into the agent scripting and automated agent software. In an embodiment, the reporting module 228 may report the topic to the agents.

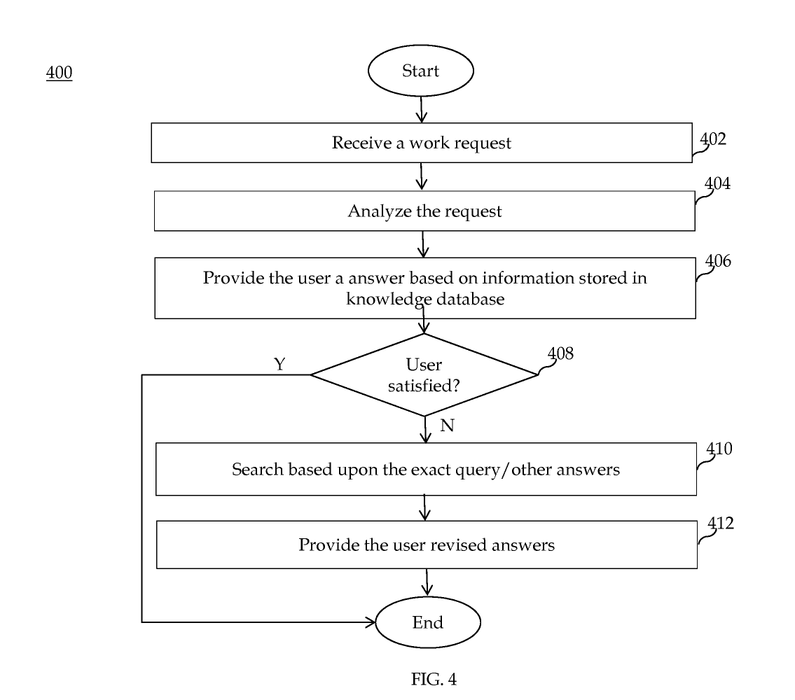

FIG. 4 illustrates a method for utilizing the knowledge database 216 to solve a customer query.

At step 402, a customer work request is received by an enterprise 208 from a user terminal 202. In an embodiment of the present invention, a customer service request may be made by making a telephone call to the enterprise 208. In another embodiment of the present invention, the customer may request for a work request by sending text messages, emails, or web chats.

At step 404, the customer work request is analyzed. For example, the customer work request may be analyzed for a type of work request e.g. a call, en email, a chat or a text message. Further, customer work request may be analyzed for detail of the work request for a customer query. It may be possible that the customer query is not complex and an agent may solve customer query or the work request based on his existing knowledge or based on existing training received by him. Further, the query may be a complex query (e.g. related to a combination of products from various manufacturers), and the agent cannot solve the query based on his existing knowledge.

At step 406, the customer query is solved based upon the knowledge stored in the knowledge database 216. The agents may retrieve an exactly matching discussion topic or substantially matching discussion topic, corresponding to the customer query, stored in the knowledge database 216 and see answer/solution stored for the given discussion topic.

At step 408, it is determined whether the customer is satisfied. The customer may get satisfied if the answer solves his problem/issue/query. If the customer is satisfied from the answer, the method 400 concludes. Otherwise, the method 400 proceeds towards step 410.

At step 410, based upon exact search query, further information is searched. It is possible that some new information/solution may be available on the preconfigured resources or general resources since last retrieval cycle. Further, new content may be searched based upon exact customer query. At step 412, the customer/user is provided with revised solutions.

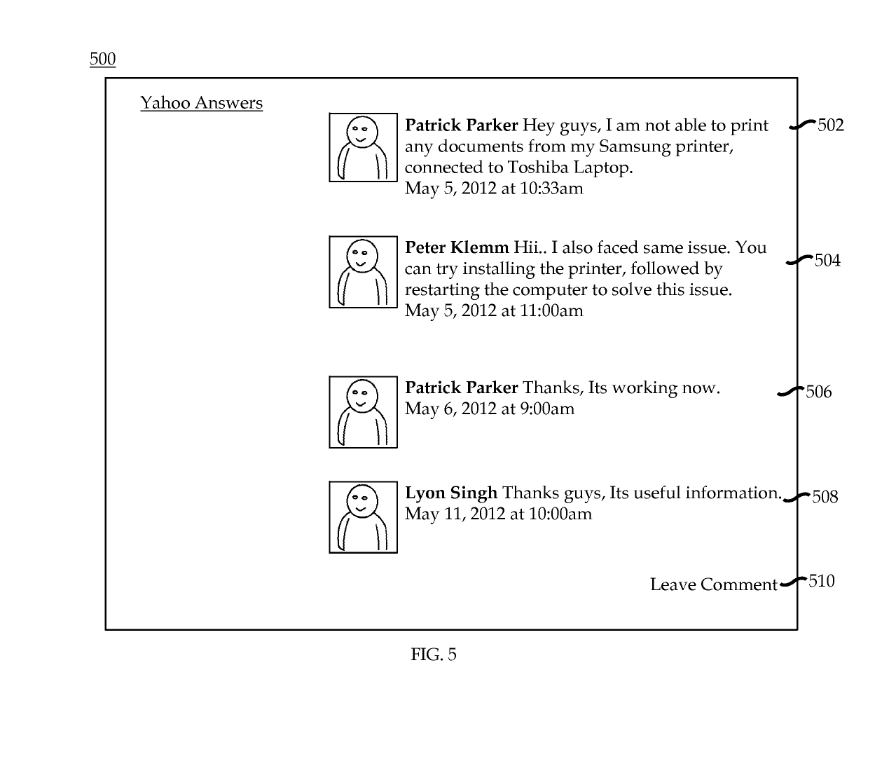

FIG. 5 illustrates an exemplary online forum (e.g. Yahoo answers) having user's comment on a particular topic. At step 502, a first user ‘Patrick Parker’ has a query and posts on the online forum. The query is “Hey guys, I am not able to print any documents from my Samsung printer, connected to Toshiba Laptop”. At step 504, a second user ‘Peter Klemm’ responds to the query as “Hi . . . I also faced same issue. You can try installing the printer, followed by restarting the computer to solve this issue.” At step 506, the first user ‘Patrick Parker’ responds with a thanks message ‘Thanks, Its working now’. At step 508, a third user ‘Lyon Singh’ also utilizes the posted information and posts ‘Thanks guys, its useful information’. At step 510, another user may post his comment.

According to an embodiment of the present invention, the training system 214 is configured to access and utilize these kinds of conversations and posts in building the knowledge database 216 and solving customer query.

An example will be illustrated now to explain above principles.

A customer contacts the contact center, through a chat. The contact center responds by launching a chat conversational process (i.e., a “chat robot” or “chat bot”). The customer says, “I have a problem hooking up my Blue Ray player with my television set.” So the chat bot, provided by an embodiment of the present invention, retrieves discussion topics stored in the knowledge database 216 and retrieves a similar discussion. The chat bot enters this discovery that the training system has done for a type of conversation thread around the topic of connecting Blue Ray players with television sets. So the chat bot would say, “Okay, I understand your problem, have you tried to do this or that.” And the customer would say, “Yes, I tried that, and that didn't work either.” So then the chat bot will go back to the training system, and say, “What have you found out about, you know, the scenario, where the customer has a problem with Blue Ray, but has tried option A and failed.” The feedback module or the training system may then respond, “Well, in that case, you know, there are conversations that we have online, and try to find that.” The feedback module or the training system may then search online based on exact customer query for latest information related to the query, and provides revised solution/answer to the customer.

The exemplary systems and methods of embodiments of the present invention have been described in relation to a user device (e.g. smart device). However, to avoid unnecessarily obscuring the present invention, the preceding description omits a number of known structures and devices. This omission is not to be construed as a limitation of the scope of the claimed invention. Specific details are set forth to provide an understanding of embodiments of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of embodiments of the present invention.

A number of variations and modifications of embodiments of the present invention can be used. It would be possible to provide for some features of the present invention without providing others.

For example in one alternative embodiment of the present invention, the systems and methods may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various embodiments of the present invention. Exemplary hardware that can be used for embodiments of the present invention may include computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of embodiments of the present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention may be described in terms of components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

Embodiments of the present invention, in various embodiments, configurations, and aspects, include components, methods, processes, systems and/or apparatus substantially as depicted and described herein, including various embodiments, sub-combinations, and subsets thereof. Those of skill in the art will understand how to make and use embodiments of the present invention after understanding the present disclosure. Embodiments of the present invention, in various embodiments, configurations, and aspects, include providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of embodiments of the present invention has been presented for purposes of illustration and description. The foregoing is not intended to limit the present invention to the form or forms disclosed herein. In the foregoing Detailed Description for example, various features of embodiments of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A training system for training agents of an enterprise, comprising:
a retrieval module configured to retrieve content from at least one predetermined resource;
a topic determining module configured to determine at least one topic based on the retrieved content;
an answer selecting module configured to select an answer for the at least one topic from the retrieved content based upon predefined rules; and
a reporting module configured to report the at least one topic and answer to one or more agents of the enterprise.

2. The training system of claim 1, wherein the retrieval module retrieves content on preconfigured intervals.

3. The training system of claim 1, wherein the retrieval module filters the content based upon preconfigured keywords.

4. The training system of claim 3, wherein the content comprises a series of user posts.

5. The training system of claim 1, wherein the at least one topic comprises an online discussion starting with a question and having one or more answers.

6. The training system of claim 1, wherein the topic determining module utilizing a Natural Language Processing engine to determine a topic from the retrieved content.

7. The training system of claim 1, wherein the answer selecting module is configured to select an answer based on positive feedback given by users to the answer.

8. The training system of claim 1, further comprising a merge module configured to merge the answer with a similar topic stored in a knowledge database.

9. The training system of claim 8, wherein the merge module is configured to classify the answer with a topic stored in the knowledge database.

10. The training system of claim 1, further comprising a feedback module configured to receive a feedback from a user for the answer.

11. The training system of claim 10, wherein the feedback module is configured to provide the user an alternative answer in case of negative feedback.

12. The training system of claim 10, wherein the feedback module is configured to search for a user query for a better answer from the predetermined online resources.

13. A computer-implemented method for training agents of an enterprise, the computer-implemented method comprising:
retrieving content from at least one predetermined resource;
determining at least one topic based on the retrieved content;
selecting an answer for the at least one topic from on the retrieved content based on predefined rules; and
reporting the at least one topic and answer to one or more agents of the enterprise.

14. The computer-implemented method of claim 13, wherein the step of retrieving content comprises filtering content based on preconfigured keywords.

15. The computer-implemented method of claim 13, wherein the at least one topic comprises an online discussion starting with a question and having one or more answers.

16. The computer-implemented method of claim 13, wherein the step of selecting an answer comprises selecting an answer based on positive feedback given by users to the answer.

17. The computer-implemented method of claim 13, further comprising the step of utilizing the answer to solve a customer query.

18. The computer-implemented method of claim 17, further comprising the step of receiving a feedback from the customer for the answer.

19. The computer-implemented method of claim 18, further comprising the step of searching again for the customer query based on the feedback.

20. A computer readable medium storing computer readable instructions when executed by a processor perform a method comprising:
retrieving content from at least one predetermined resource;
determining at least one topic based on the retrieved content;
selecting an answer for the at least one topic from the retrieved content based on predefined rules; and
reporting the at least one topic and answer to one or more agents of the enterprise.
